(19) United States
(12) Patent Application Publication
(10) Pub. No.: US 2026/0108106 A1
(43) Pub. Date: Apr. 23, 2026

(54) ENERGY SAVING SYSTEM FOR TOASTER APPLIANCES

(71) Applicant: A. J. ANTUNES & CO., Carol Stream, IL (US)

(72) Inventors: BHUPENDRA PATEL, Carol Stream, IL (US); Wu Hongfei, Suzhou (CN); Zhu Yongjian, Suzhou (CN)

(21) Appl. No.: 18/924,135

(22) Filed: Oct. 23, 2024

(51) Int. Cl. A47J 37/08; F24C 7/06; F24C 15/22

(52) U.S. Cl. CPC A47J 37/0807; A47J 37/0857; F24C 7/067; F24C 15/22

(57) ABSTRACT

A toaster appliance comprises a main platen and a pair of Calrod®-type auxiliary heaters. A pair of heat reflectors are operatively associated with the Calrod®-type auxiliary heaters so as to effectively reflect heat back into central interior spaces of the toaster appliance and for simultaneously preventing heat from escaping into outer interior spaces of the toaster appliance. In addition, dampers, automatically biased to their closed positions, are utilized at both the infeed and outfeed locations of the toaster appliance so as to effectively retain the heat within the interior of the toaster appliance and to effectively prevent the loss of such heat from within the interior of the toaster appliance as a result of such heat tending to otherwise escape from the interior of the toaster appliance.

### FIELD OF THE INVENTION

The present invention relates generally to food service equipment, and more particularly to an energy saving system for toaster appliances.

### BACKGROUND OF THE INVENTION:

Fast-food restaurants serving hot sandwiches conventionally use contact toasters for toasting the bread products utilized in the making of sandwiches. Some examples of such bread products would include hamburger buns, sliced bread, hot dog buns, English muffins, and the like. Contact toaster appliances conventionally comprise a main platen which caramelizes the inside surfaces of the bread product as a result of direct contact of the bread product with the hot surface of the main platen. In turn, the outer surfaces of the bread products are warmed by means of a pair of Calrod®-type auxiliary heaters as a result of radiant heat being emitted from the Calrod®-type auxiliary heaters, as well as by conductive heat derived from the warm air surrounding the bread products. Along these lines, store owners prefer to use high-efficiency equipment in order to reduce energy costs which obviously affect their business operating costs and expenses. Unfortunately, with such conventional toaster appliances, heat losses occur due to the open interior space within the toaster enclosure surrounding the main platen and the auxiliary heaters, as well as due to openings at both the infeed and outfeed ends of the toaster appliance. Accordingly, such sources of heat loss contribute to a necessary increase in the power, and therefore energy costs, required to maintain the heat levels within the toaster appliance as required by means of a predetermined or preset temperature setpoint.

A need therefore exists in the art for a new and improved toaster appliance. Another need exists in the art for a new and improved toaster appliance wherein the toaster appliance can be rendered more efficient. Still another need exists in the art for a new and improved toaster appliance wherein the toaster appliance can be rendered more efficient by effectively reducing heat losses from within the toaster appliance. Yet another need exists in the art for a new and improved toaster appliance wherein the toaster appliance can be rendered more efficient by effectively reducing heat losses from within the toaster appliance whereby power requirements within the toaster appliance can accordingly be reduced. Yet still another need exists in the art for a new and improved toaster appliance wherein the toaster appliance can be rendered more efficient by effectively reducing heat losses from within the toaster appliance whereby power requirements within the toaster appliance can accordingly be reduced such that heat levels within the toaster appliance, as required by means of a predetermined or preset temperature setpoint, can be readily maintained without enhanced power requirements. An additional need exists in the art for a new and improved toaster appliance wherein the toaster appliance can be rendered more efficient by effectively reducing heat losses from within the toaster appliance whereby power requirements within the toaster appliance can accordingly be reduced such that heat levels within the toaster appliance, as required by means of a predetermined or preset temperature setpoint, can be readily maintained, without enhanced power requirements, so as to, in turn, reduce operating costs.

### OVERALL OBJECTIVES OF THE INVENTION

A first overall objective of the present invention is to provide a new and improved toaster appliance. Another overall objective of the present invention is to provide a new and improved toaster appliance wherein the toaster appliance can be rendered more efficient. Still another overall objective of the present invention is to provide a new and improved toaster appliance wherein the toaster appliance can be rendered more efficient by effectively reducing heat losses from within the toaster appliance. Yet another overall objective of the present invention is to provide a new and improved toaster appliance wherein the toaster appliance can be rendered more efficient by effectively reducing heat losses from within the toaster appliance whereby power requirements within the toaster appliance can accordingly be reduced. Yet still another overall objective of the present invention is to provide a new and improved toaster appliance wherein the toaster appliance can be rendered more efficient by effectively reducing heat losses from within the toaster appliance whereby power requirements within the toaster appliance can accordingly be reduced such that heat levels within the toaster appliance, as required by means of a predetermined or preset temperature setpoint, can be readily maintained without enhanced power requirements. An additional overall objective of the present invention is to provide a new and improved toaster appliance wherein the toaster appliance can be rendered more efficient by effectively reducing heat losses from within the toaster appliance whereby power requirements within the toaster appliance can accordingly be reduced such that heat levels within the toaster appliance, as required by means of a predetermined or preset temperature setpoint, can be readily maintained, without enhanced power requirements, so as to, in turn, reduce operating costs.

### SUMMARY OF THE INVENTION

The foregoing and other objectives are achieved in accordance with the principles and teachings of the present invention through the provision of a toaster appliance wherein the toaster appliance comprises a centrally located main platen, which caramelizes the inside surfaces of the bread as a result of direct contact of the bread product with the hot surface of the main platen, and a pair of Calrod®-type auxiliary heaters for warming the outer surfaces of the bread products by radiant heat being emitted from the Calrod®-type auxiliary heaters. In accordance with the principles and teachings of the present invention, a pair of heat reflectors are operatively associated with each one of the Calrod®-type auxiliary heaters so as to effectively reflect heat back into the interior spaces of the toaster appliance which are defined between the main platen and the pair of Calrod®-type auxiliary heaters, and for simultaneously preventing heat from escaping into those interior spaces of the toaster appliance which are defined between the pair of Calrod®-type auxiliary heaters and the outer regions of the toaster appliance. Still further, in accordance with additional principles and teachings of the present invention, dampers, automatically biased to their closed positions, are utilized at both the infeed and outfeed locations of the toaster appliance so as to effectively retain the heat within the interior of the toaster appliance and to effectively prevent the loss of such heat from within the interior of the toaster appliance as a result of such heat tending to otherwise escape from the interior of the toaster appliance.

### BRIEF DESCRIPTION OF THE DRAWINGS

Various other objects, features and attendant advantages of the present invention will be more fully appreciated from the following detailed description when considered in connection with the accompanying drawings in which like reference characters designate like or corresponding parts throughout the several views, and wherein:

FIG. 1 is a schematic cross-sectional view of a toaster appliance showing a centrally located main platen and a pair of oppositely disposed outer Calrod®-type auxiliary heaters with heat reflectors respectively mounted behind the pair of oppositely disposed outer Calrod®-type auxiliary heaters so as to reflect heat back into the interior regions of the toaster appliance;

FIG. 2 is a perspective view of one of the pair of reflectors which is adapted to be mounted behind the pair of Calrod®-type auxiliary heaters so as to reflect heat back into the interior regions of the toaster appliance;

FIG. 3 is a perspective view of one of the pair of reflectors adapted to be mounted behind the pair of Calrod®-type auxiliary heaters, similar to that as shown in FIG. 2, with the Calrod®-type auxiliary heater mounted thereon, so as to reflect heat back into the interior regions of the toaster appliance;

FIG. 4 is a rear elevational view showing one of the reflectors as fixedly mounted upon the toaster appliance so as to effectively prevent heat losses from the central interior regions of the toaster appliance to the outer interior regions of the toaster appliance;

FIG. 5 is a front elevational view showing one of the reflectors as fixedly mounted upon the toaster appliance, and being disposed behind a respective one of the pair of Calrod®-type auxiliary heaters, so as to effectively prevent heat losses from the central interior regions of the toaster appliance to the outer interior regions of the toaster appliance;

FIG. 5a is a perspective view, corresponding to the front elevational view of FIG. 5, showing, in greater detail, how one of the reflectors is fixedly mounted upon the toaster appliance, and being disposed behind a respective one of the pair of Calrod®-type auxiliary heaters, so as to effectively prevent heat losses from the central interior regions of the toaster appliance to the outer interior regions of the toaster appliance;

FIG. 6 is a perspective view of one of the infeed damper mechanisms to be mounted upon the infeed region of the toaster appliance;

FIG. 7 is a schematic cross-sectional view of the infeed damper mechanism disclosed within FIG. 6 showing the structural makeup of the infeed damper which renders the same capable of automatically closing after a bread product has passed thereby;

FIG. 8 is a perspective view of the infeed region of the toaster appliance showing the infeed damper mechanisms mounted thereon;

FIG. 9 is a perspective view of the outfeed damper mechanism as mounted within its framework; and

FIG. 10 is a perspective view of the outfeed damper mechanism, as illustrated within FIG. 9, as mounted upon the outfeed region of the toaster appliance.

### DETAILED DESCRIPTION OF THE PREFERRED EMBODIMENT

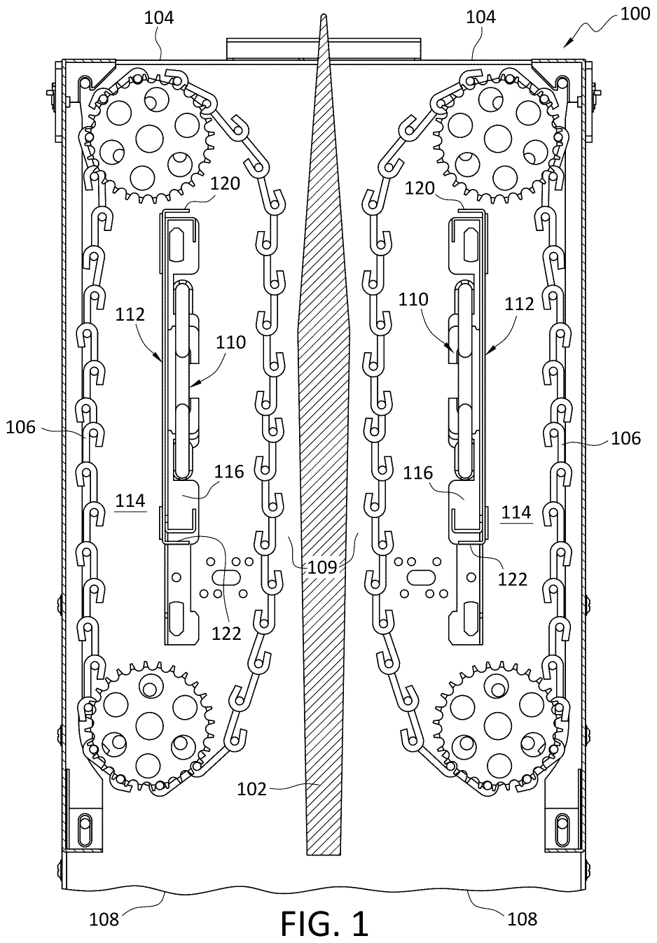

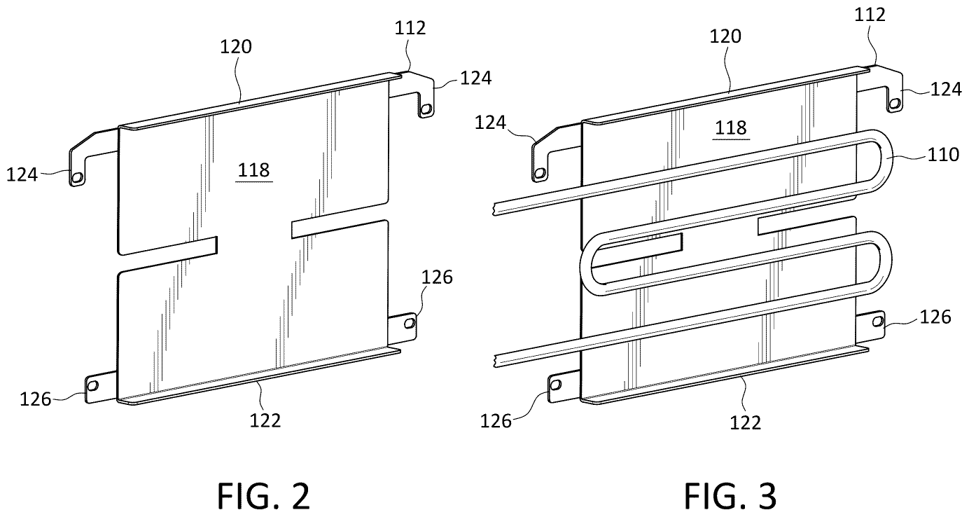

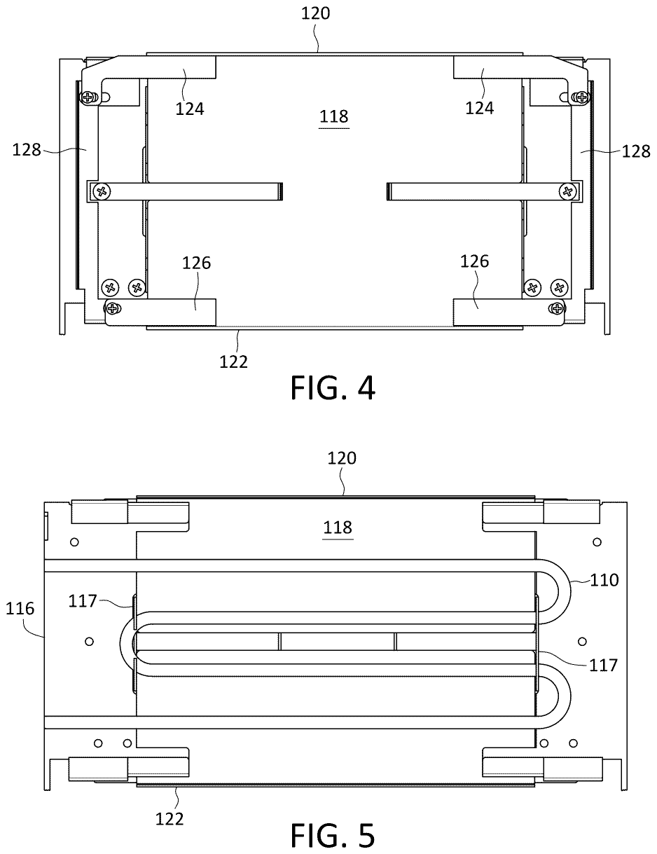

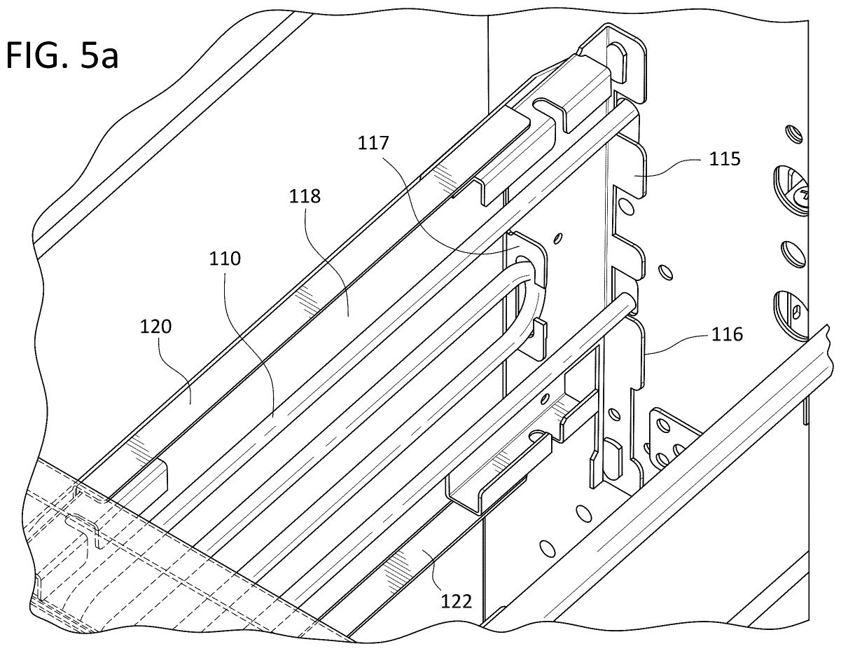

Referring now to the drawings, and more particularly to FIG. 1 thereof, a new and improved toaster appliance, developed in accordance with the principles and teachings of the present invention, is disclosed and is generally indicated by the reference character 100. More particularly, it is seen that the toaster appliance 100 comprises a centrally located main platen 102 which is adapted to caramelize the inside surfaces of the bread product as a result of direct contact of the bread product with the hot surface of the main platen 102, and at the top of the toaster appliance 100, there are a pair of infeed slots 104,104 through which bread products, to be toasted, are adapted to be fed. The bread products can be anyone of those commonly used within a fast-food restaurant, such as, for example, hamburger buns, sliced bread, hot dog rolls, English muffins, and the like. Continuing further, internally within the toaster appliance 100 and located upon opposite sides of the centrally located main platen 102, there are a pair of vertically oriented, endless, motor-driven chain and sprocket drive mechanisms 106,106 which are adapted to convey the bread products through the interior region of the toaster appliance 100 from the infeed region defined by means of the infeed slots 104,104 to an outfeed region defined by means of a pair of outfeed slots 108,108, and along paths 109,109. In addition, a pair of Calrod®-type auxiliary heaters 110,110 are laterally spaced from the centrally located main platen 102 for warming the outer surfaces of the bread products by radiant heat being emitted from the Calrod®-type auxiliary heaters 110,110. Still further, in accordance with the principles and teachings of the present invention, a pair of heat reflectors 112,112 are operatively associated respectively with each one of the Calrod®-type auxiliary heaters 110,110 so as to effectively reflect radiant heat, from said pair of Calrod®-type auxiliary heaters 110,110, back into the interior spaces of the toaster appliance 100 which are defined between the main platen 102 and the pair of Calrod®-type auxiliary heaters 110,110, and for simultaneously preventing heat from escaping into those interior spaces 114,114 of the toaster appliance 100 which are defined between the pair of Calrod®-type auxiliary heaters 110,110 and the outer regions of the toaster appliance 100. As can best be appreciated from FIG. 1, each one of the pair of Calrod®-type auxiliary heaters 110,110 is mounted within a suitable sheet-metal bracket 116,116. More particularly, it is seen that each one of the sheet-metal brackets 116,116 comprises a pair of laterally outer, notched mounting flanges 115 within which terminal end portions of the Calrod®-type auxiliary heaters 110,110 can be disposed, and at least one laterally inner, notched mounting flange 117 within which an intermediate portion of each Calrod®-type auxiliary heater 110 can be disposed. In turn, as can best be appreciated from FIGS. 2-5a, it is seen that each one of the heat reflectors 112,112 comprises a substantially square or rectangular flat plate 118 which has flanged portions 120,122 extending along the upper or top and lower or bottom edge portions thereof. In addition, each one of the heat reflectors 112,112 also include pairs of upper and lower tab members 124,126 which permit the heat reflectors 112,112 to be fixedly attached to frame structure 128 of the toaster appliance 100, as can best be seen in FIG. 4, whereby the heat reflectors 112,112 will be in close proximity to the pair of Calrod®-type auxiliary heaters 110,110. In addition, the provision of the flanged portions of the heat reflectors 112,112 serve to effectively enclose the Calrod®-type auxiliary heaters 110,110 so as to facilitate the overall objective or goal of heat reflection.

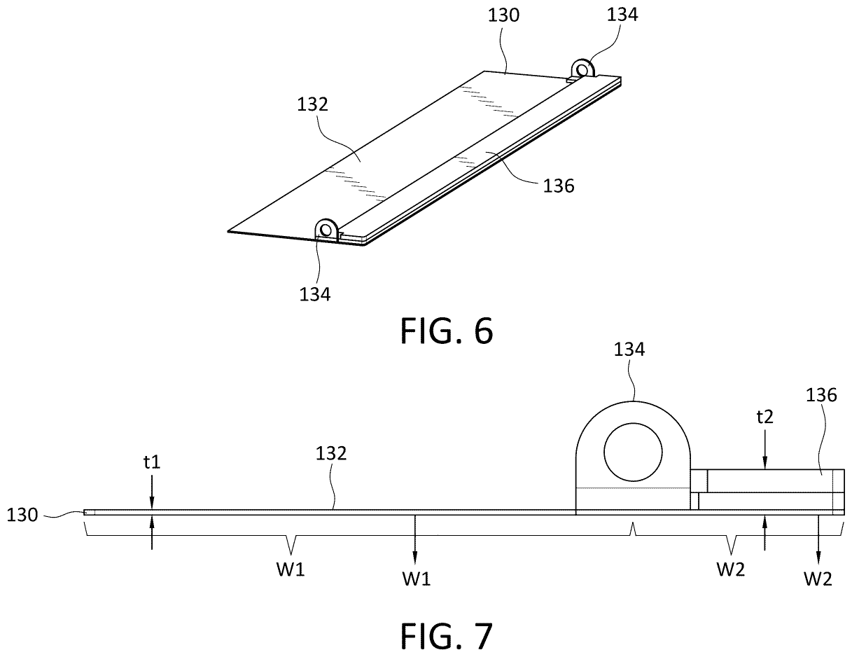

Continuing further, and in accordance with additional principles and teachings of the present invention, dampers, automatically biased to their closed positions, are utilized at both the infeed and outfeed locations of the toaster appliance 100 so as to effectively retain the heat within the interior of the toaster appliance 100 and to effectively prevent the loss of such heat from within the interior of the toaster appliance 100 as a result of such heat tending to otherwise escape from the interior of the toaster appliance 100. More particularly, and with reference being made to FIGS. 6-8, an infeed damper 130 is disclosed. Infeed dampers 130,130 are utilized at the infeed slots 104,104 of the toaster appliance 100, and as shown in FIGS. 6 and 7, each infeed damper 130 comprises, in effect, a first or main plate 132 having a first predetermined thickness t1, a first effective width w1, as measured from its free edge portion to the point at which the damper 130 is pivotally mounted upon the toaster appliance 100 at the infeed slot 104 as defined by means of a pair of oppositely disposed shaft housings 134, 134, and a first weight W1.

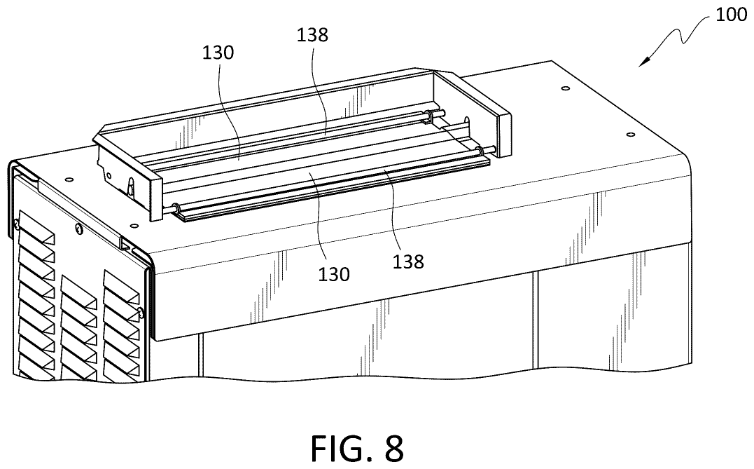

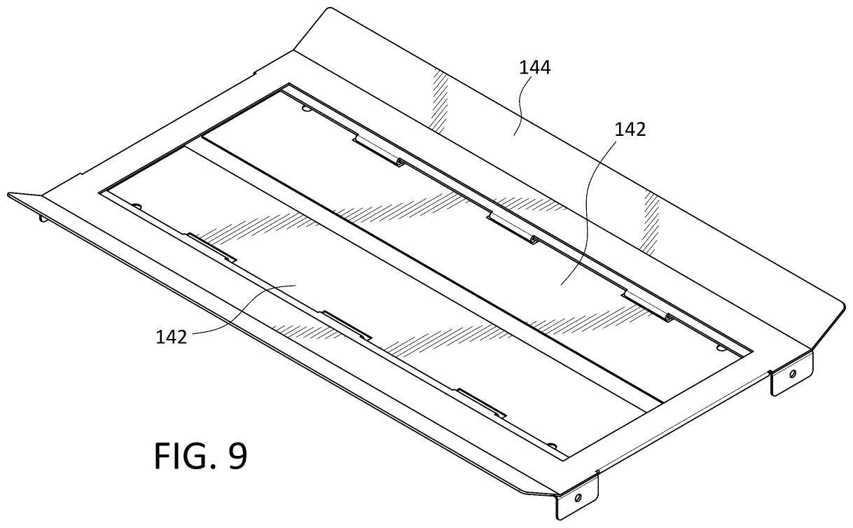

On the opposite lateral side of the pair of oppositely disposed shaft housings 134,134, the damper 130 effectively comprises a secondary plate 136 which has a second predetermined thickness t2 which is several times that of the first or main plate 132, an effective width w2, as measured from its free edge portion to the point at which the damper 130 is pivotally mounted upon the toaster appliance 100 at the infeed slot 104 as defined by means of a pair of oppositely disposed shaft housings 134, 134, and a second weight W2. The mounting of the indeed dampers 130,130 at the infeed region of the toaster appliance can be appreciated from FIG. 8 wherein it is seen that each one of the infeed dampers 130,130 is pivotally mounted upon the toaster appliance 100 by means of an axle or shaft 138,138. It is also to be noted that the weight W2 of the secondary plate 136, effectively acting through its width or moment arm w2, is greater than the weight W1 of the first or main plate 132 effectively acting through its width or moment arm w1. Accordingly, it can be readily appreciated that when bread products are inserted through the infeed slots 104,104, the infeed dampers 130,130 will be deflected away from their normal, closed positions, however, since the weight W2, acting through its width or moment arm w2, is greater than the weight W1, acting through its width or moment arm w1, each infeed damper 130 will experience a moment which will tend to automatically return it to its normal, closed position after having been deflected away from such normal, closed positions, and after the particular bread product has passed the infeed damper 130,130.

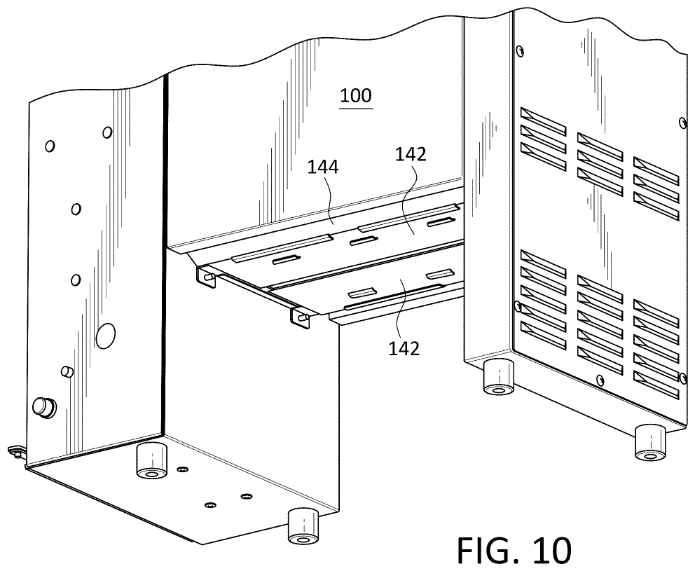

With reference lastly being made to FIGS. 9 and 10, a pair of outfeed damper flaps 142,142 are disclosed so as to cover the outfeed slots 108,108. The outfeed dampers 142,142 are pivotally mounted within a metal frame 144, and each one of the outfeed dampers 142,142 comprises an inherently flexible flap fabricated from PTFE (polytetrafluoroethylene). Alternatively, of course, the outfeed dampers 142,142 may effectively be similar to the infeed dampers 132,132. As the bread products are moved through the toaster appliance 100, they will push open the outfeed dampers 142,142, which will flexibly move from their normally closed positions to open positions, and once the bread products have cleared the outfeed dampers 142,142, the outfeed dampers 142,142 will automatically return to their normally closed positions.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent, is:

1. A toaster appliance, comprising:
a centrally located main platen for heating first side surface portions of bread products;
a pair of auxiliary heaters laterally spaced from, and disposed upon opposite sides of, said centrally located main platen for heating second side surface portions of the bread products; and
a pair of reflectors, operatively associated with said pair of auxiliary heaters and disposed on sides of said pair of auxiliary heaters which are opposite sides of said auxiliary heaters which face said centrally located platen, for reflecting radiant heat from said pair of auxiliary heaters back into interior regions of said toaster appliance such that said radiant heat is not effectively lost within other interior regions of said toaster appliance.

2. The toaster appliance as set forth in claim 1, wherein:
each one of said reflectors comprises a reflector plate.

3. The toaster appliance as set forth in claim 1, further comprising:
a pair of infeed slots through which bread products can be fed into said toaster appliance; and
a pair of outfeed slots through which bread products can be discharged from said toaster appliance.

4. The toaster appliance as set forth in claim 3, further comprising:
a pair of conveyors interposed between said centrally located main platen and said pair of auxiliary heaters for conveying bread products through said toaster appliance from said pair of infeed slots to said pair of outfeed slots.

5. The toaster appliance as set forth in claim 4, wherein:
said pair of conveyors comprise motor-driven chain and sprocket conveyors.

6. The toaster appliance as set forth in claim 3, further comprising:
a pair of infeed dampers operatively associated with said pair of infeed slots,
wherein said pair of infeed dampers are biased toward their normally closed positions, after being deflected from said normally closed positions by insertion of bread products through said infeed slots, so as to effectively retain heat within the interior of said toaster appliance and to effectively prevent the loss of such heat from within the interior of said toaster appliance as a result of such heat tending to otherwise escape from the interior of said toaster appliance.

7. The toaster appliance as set forth in claim 6, wherein:
each one of said infeed dampers is pivotally mounted, at a predetermined pivotal location, upon said toaster appliance so as to be normally biased to its closed position.

8. The toaster appliance as set forth in claim 7, wherein:
each one of said infeed dampers comprises first and second plates wherein said first plate has a greater moment, due to its weight acting through its moment arm with respect to its pivotal location upon said toaster appliance, than a moment of said second plate, due to its weight acting through its moment arm with respect to its pivotal location upon said toaster appliance, such that each one of said infeed dampers automatically returns to said normally closed position, from said deflected position, once the bread product clears said infeed damper as the bread product is inserted through one of said infeed slots.

9. The toaster appliance as set forth in claim 3, further comprising:
a pair of outfeed dampers operatively associated with said pair of outfeed slots,
wherein said pair of outfeed dampers are biased toward their normally closed positions, after being deflected from said normally closed positions by a discharge of bread products through said outfeed slots, so as to effectively retain heat within the interior of said toaster appliance and to effectively prevent the loss of such heat from within the interior of said toaster appliance as a result of such heat tending to otherwise escape from the interior of said toaster appliance.

10. The toaster appliance as set forth in claim 9, wherein:
each one of said outfeed dampers is fabricated from PTFE (polytetrafluoroethylene).
